(19) United States
(12) Patent Application Publication
(10) Pub. No.: US 2006/0095233 A1
(43) Pub. Date: May 4, 2006

(54) Method and systems for determining conditional failures within vehicles

(76) Inventors: Bernard J. Carr, Santa Barbara, CA (US); Nathan Perry, Goleta, CA (US); Kevin J. Gehris, Santa Barbara, CA (US); Kent E. Antognini, Lompoc, CA (US)

Correspondence Address: Erik G. Swenson;Merchant & Gould P.C., P.O. Box 2903, Minneapolis, MN, 55402-0903, US

(21) Appl. No.: 10/979,746

(22) Filed: Nov. 2, 2004

(51) Int. Cl. G21C 17/00

(52) U.S. Cl. 702/185

(57) ABSTRACT

A method of determining a cylinder that has a failure in an engine includes accessing an on-board information system associated with the engine; retrieving data from the on-board information system; filtering the data to derive at target data; and decoding the target data to determine a number of a failed cylinder and the cylinder's corresponding cylinder rating. A system for determining a cylinder that has a failure in an engine includes an access module, a retrieve module, a filter module, and a decode module. The access module accesses an on-board information system associated with the engine. The retrieve module retrieves data from the on-board information system. The filter module filters the data to derive at target data. The decode module decodes the target data to determine a number of a failed cylinder and the cylinder's corresponding cylinder rating.

### TECHNICAL FIELD

The present invention relates to engine diagnostics, and more particularly to methods for determining conditional failures within vehicles.

### BACKGROUND

Internal combustion engines frequently misfire on one or more cylinders, requiring repair to that cylinder or cylinders. In order to diagnose such engines, one must determine which cylinder is encountering a problem. The diagnostics typically involve disabling a cylinder and then monitoring the resulting engine performance. Each cylinder is evaluated to determine which cylinder or cylinders is encountering a problem. In general, if a properly operating cylinder is disabled, the engine will run rougher. Conversely, if a non-properly operating cylinder is disabled, there will be little impact on the performance of the engine. By systematically disabling the cylinders of the engine one at a time, one can locate the defective cylinder.

A variety of techniques for disabling a cylinder are known, such as that described in U.S. Pat. No. 4,027,532 (the '532 patent). There are disadvantages to these prior systems. One such disadvantage is that they are difficult to connect to the engine. In today's engines, the component parts are less accessible and are often hidden under plastic cladding. So, attaching all the necessary leads to disable a cylinder is a daunting task. In FIG. 1 of the '532 patent, several different leads are required to perform the test. In today's engine, most of those engine components are inaccessible.

Therefore, improvements are desirable.

### SUMMARY

In accordance with the present invention, the above and other problems are solved by the following:

In one aspect of the present invention, a method of determining a cylinder that has a failure in an engine is disclosed. The method includes accessing an on-board information system associated with the engine; retrieving data from the on-board information system; filtering the data to derive at target data; and decoding the target data to determine a number of a failed cylinder and the cylinder's corresponding cylinder rating.

In another aspect of the present invention, a system for determining a cylinder that has a failure in an engine is disclosed. The system includes an access module, a retrieve module, a filter module, and a decode module. The access module accesses an on-board information system associated with the engine. The retrieve module retrieves data from the on-board information system. The filter module filters the data to derive at target data. The decode module decodes the target data to determine a number of a failed cylinder and the cylinder's corresponding cylinder rating.

In yet another aspect of the present invention, a computer program product readable by a computing system and encoding instructions for determining a cylinder that has a failure in an engine is disclosed. The computer process includes accessing an on-board information system associated with the engine; retrieving data from the on-board information system; filtering the data to derive at target data; and decoding the target data to determine a number of a failed cylinder and the cylinder's corresponding cylinder rating.

In yet another aspect of the present invention, a system for diagnosing an internal combustion engine is disclosed. The system includes a computing system, a connection device, and a first device. The computing system executes an algorithm that evaluates a contribution of a cylinder in the internal combustion engine. The connection device connects the computing system to an on-board information system of the internal combustion engine. The first device connects the computer system to a vacuum port of the internal combustion engine.

In yet another aspect of the present invention, a graphical user interface that is used in conjunction with a diagnostic system for diagnosing an internal combustion engine having a plurality of cylinders is disclosed. The graphical user interface includes a first field, a second field, and a graphical representation of the first field and the second field. The first field displays target information regarding the internal combustion engine. The second field displays instantaneous information regarding the internal combustion engine.

The invention may be implemented as a computer process; a computing system, which may be distributed; or as an article of manufacture such as a computer program product. The computer program product may be a computer storage medium readable by a computer system and encoding a computer program of instructions for executing a computer process. The computer program product may also be a propagated signal on a carrier readable by a computing system and encoding a computer program of instructions for executing a computer process.

A more complete appreciation of the present invention and its scope may be obtained from the accompanying drawings, which are briefly described below, from the following detailed descriptions of presently preferred embodiments of the invention and from the appended claims.

### BRIEF DESCRIPTION OF THE DRAWINGS

Referring now to the drawings in which like reference numbers represent corresponding parts throughout:

FIG. 1 is a schematic representation of methods and systems for engine diagnostics, according to an exemplary embodiment of the present disclosure;

FIG. 2 is a schematic representation of a computing system that may be used to implement aspects of the present disclosure;

FIG. 3 is a block diagram of an internal combustion engine; according to an exemplary embodiment of the present disclosure;

FIG. 4 is a block diagram of a diagnostic system connected to a vehicle, according to an exemplary embodiment of the present disclosure;

FIG. 5 illustrates a logical process flow diagram of a diagnostic system, according to an exemplary embodiment of the present disclosure;

FIG. 6 illustrates an example graphic user interface of a diagnostic system, according to an exemplary embodiment of the present disclosure;

FIG. 7 illustrates an example graphic user interface of a diagnostic system, according to an exemplary embodiment of the present disclosure;

FIG. 8 illustrates an example graphic user interface of a diagnostic system, according to an exemplary embodiment of the present disclosure;

FIG. 9 illustrates an example graphic user interface of a diagnostic system, according to an exemplary embodiment of the present disclosure;

FIG. 10 illustrates an example graphic user interface of a diagnostic system, according to an exemplary embodiment of the present disclosure;

FIG. 11 illustrates an example graphic user interface of a diagnostic system, according to an exemplary embodiment of the present disclosure;

FIG. 12 illustrates an example graphic user interface of a diagnostic system, according to an exemplary embodiment of the present disclosure;

FIG. 13 illustrates an example graphic user interface of a diagnostic system, according to an exemplary embodiment of the present disclosure;

FIG. 14 illustrates an example graphic user interface of a diagnostic system, according to an exemplary embodiment of the present disclosure;

FIG. 15 illustrates an example graphic user interface of a diagnostic system, according to an exemplary embodiment of the present disclosure;

FIG. 16 illustrates an example graphic user interface of a diagnostic system, according to an exemplary embodiment of the present disclosure;

FIG. 17 illustrates an example graphic user interface of a diagnostic system, according to an exemplary embodiment of the present disclosure;

FIG. 18 illustrates an example graphic user interface of a diagnostic system, according to an exemplary embodiment of the present disclosure;

FIG. 19 illustrates an example graphic user interface of a diagnostic system, according to an exemplary embodiment of the present disclosure;

FIG. 20 illustrates an example graphic user interface of a diagnostic system, according to an exemplary embodiment of the present disclosure;

FIG. 21 illustrates an example graphic user interface of a diagnostic system, according to an exemplary embodiment of the present disclosure;

FIG. 22 illustrates a logical process flow diagram of a diagnostic system, according to an example embodiment of the present invention;

FIG. 23 illustrates contents of a test log output, according to an example embodiment of the present invention; and

FIG. 24 is a block diagram of a diagnostic system, according to an example embodiment of the present invention.

### DETAILED DESCRIPTION

In the following description of preferred embodiments of the present invention, reference is made to the accompanying drawings that form a part hereof, and in which is shown by way of illustration specific embodiments in which the invention may be practiced. It is understood that other embodiments may be utilized and changes may be made without departing from the scope of the present invention.

In general, the present disclosure describes methods and systems for determining conditional failures within ground-based mobile vehicle electronic systems. The methods and systems utilize digital data from the self-diagnostic portion of on-board control units to determine the source of a component or sub-system fault. This is a functional test that determines, by query from the Electronic Control Unit (ECU), which cylinder, or cylinders, has a problem.

The methods and systems first utilize a vehicle network interface module to interact with on-board vehicle electronic control units. This vehicle interface module utilizes standard vehicle communication protocols and diagnostic test mode data that are available on all passenger cars and light duty trucks since 1996 with a Gross Vehicle Weight Rating less than 8500 lbs (14,000 lbs in California). Specific information from the vehicle On-Board Diagnostics (OBD) ECU is accessed and evaluated by a series of rule-based algorithms. The final output of this process is the identification of the failed cylinder, or cylinders, number and whether the failure is mechanical, ignition, or fuel system related.

In addition, the methods and systems can have the ability to measure analog measurements of the engine's manifold pressure. The methods and systems can take physical measurement of the engine vacuum using a peripheral vacuum probe and store the values into system memory.

There are several advantages to the methods and systems described herein. These advantages include, for example, determining where a potential fault might lie; evaluate key information from vehicle ECUs; process vehicle data against a rule-based system; present the results in an easily understood format; disconnection of underhood components, circuits, or system links is not required; uses data from factory programmed OBD systems to make decisions; and employs the on-vehicle freeze data to enable the user to operate the vehicle at the same conditions that were present when the problem occurred.

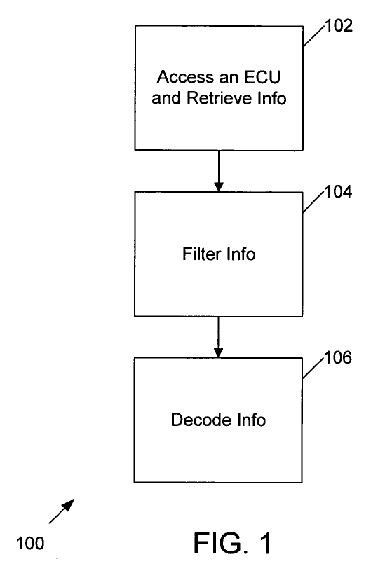

Referring now to FIG. 1, an example schematic representation of a diagnosing system 100 is illustrated. An access operation 102 accesses an ECU and retrieves information, such as failure information, or data, from the ECU. A filter operation 104 filters the data to derive at target data. A decode operation 106 decodes the target data to determine a number of a failed cylinder and the cylinder's corresponding cylinder rating.

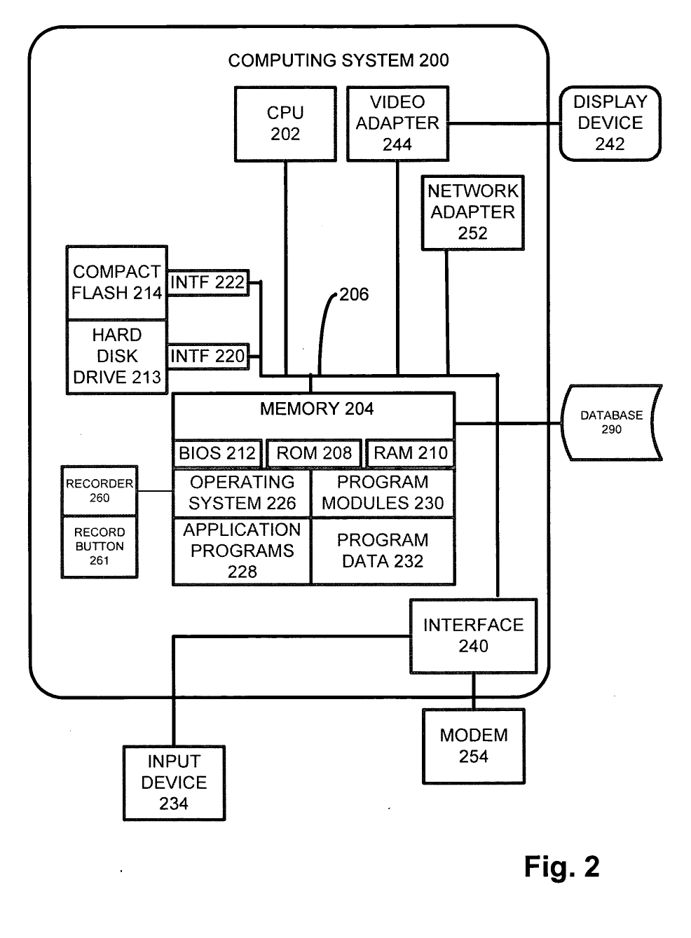

FIG. 2 and the following discussion are intended to provide a brief, general description of a suitable computing environment in which the present invention might be implemented. Although not required, the present invention can be described in the general context of computer-executable instructions, such as program modules, being executed by a computing system. Generally, program modules include routines, programs, objects, components, data structures, etc. that perform particular tasks or implement particular abstract data types.

Those skilled in the art will appreciate that the present invention might be practiced with other computer system configurations, including handheld devices, palm devices, multiprocessor systems, microprocessor-based or programmable consumer electronics, network personal computers, minicomputers, mainframe computers, and the like. The present invention might also be practiced in distributed computing environments where tasks are performed by remote processing devices that are linked through a communications network. In a distributed computing environment, program modules might be located in both local and remote memory storage devices.

Referring now to FIG. 2, an exemplary environment for implementing embodiments of the present invention includes a general purpose computing device in the form of a computing system 200, including at least one processing system 202. A variety of processing units are available from a variety of manufacturers, for example, Intel Advanced Micro Devices, or Motorola. The computing system 200 also includes a system memory 204, and a system bus 206 that couples various system components including the system memory 204 to the processing unit 202. The system bus 206 might be any of several types of bus structures including a memory bus, or memory controller; a peripheral bus; and a local bus using any of a variety of bus architectures.

Preferably, the system memory 204 includes read only memory (ROM) 208 and random access memory (RAM) 210. A basic input/output system 212 (BIOS), containing the basic routines that help transfer information between elements within the computing system 200, such as during start-up, is typically stored in the ROM 208.

Preferably, the computing system 200 further includes a secondary storage device 213, such as a hard disk drive, for reading from and writing to a hard disk (not shown), and/or a compact flash card 214.

The hard disk drive 213 and compact flash card 214 are connected to the system bus 206 by a hard disk drive interface 220 and a compact flash card interface 222, respectively. The drives and cards and their associated computer-readable media provide nonvolatile storage of computer readable instructions, data structures, program modules and other data for the computing system 200.

Although the exemplary environment described herein employs a hard disk drive 213 and a compact flash card 214, it should be appreciated by those skilled in the art that other types of computer-readable media, capable of storing data, can be used in the exemplary system. Examples of these other types of computer-readable mediums include magnetic cassettes, flash memory cards, digital video disks, Bernoulli cartridges, CD ROMS, DVD ROMS, random access memories (RAMs), read only memories (ROMs), and the like.

A number of program modules may be stored on the hard disk 213, compact flash card 214, ROM 208, or RAM 210, including an operating system 226, one or more application programs 228, other program modules 230, and program data 232. A user may enter commands and information into the computing system 200 through an input device 234. Examples of input devices might include a keyboard, mouse, microphone, joystick, game pad, satellite dish, scanner, digital camera, touch screen, and a telephone. These and other input devices are often connected to the processing unit 202 through an interface 240 that is coupled to the system bus 206. These input devices also might be connected by any number of interfaces, such as a parallel port, serial port, game port, or a universal serial bus (USB). A display device 242, such as a monitor or touch screen LCD panel, is also connected to the system bus 206 via an interface, such as a video adapter 244. The display device 242 might be internal or external. In addition to the display device 242, computing systems, in general, typically include other peripheral devices (not shown), such as speakers, printers, and palm devices.

When used in a LAN networking environment, the computing system 200 is connected to the local network through a network interface or adapter 252. When used in a WAN networking environment, such as the Internet, the computing system 200 typically includes a modem 254 or other means, such as a direct connection, for establishing communications over the wide area network. The modem 254, which can be internal or external, is connected to the system bus 206 via the interface 240. In a networked environment, program modules depicted relative to the computing system 200, or portions thereof, may be stored in a remote memory storage device. It will be appreciated that the network connections shown are exemplary and other means of establishing a communications link between the computing systems may be used.

The computing system 200 might also include a recorder 260 connected to the memory 204. The recorder 260 includes a microphone for receiving sound input and is in communication with the memory 204 for buffering and storing the sound input. Preferably, the recorder 260 also includes a record key 261 for activating the microphone and communicating the sound input to the memory 204.

A computing device, such as computing system 200, typically includes at least some form of computer-readable media. Computer readable media can be any available media that can be accessed by the computing system 200. By way of example, and not limitation, computer-readable media might comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium that can be used to store the desired information and that can be accessed by the computing system 200.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media. Computer-readable media may also be referred to as computer program product.

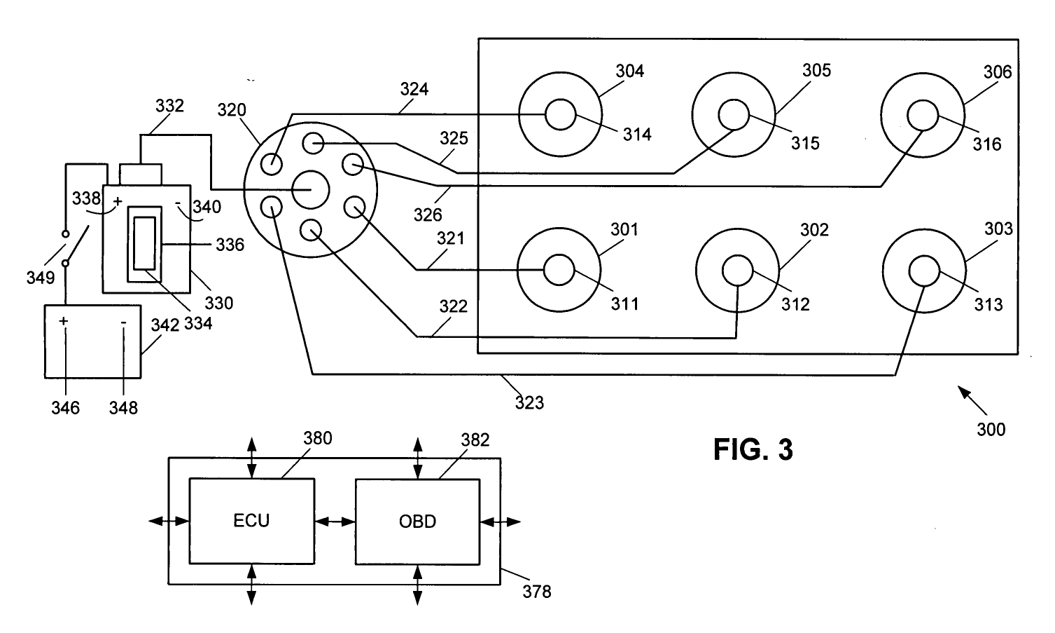

FIG. 3 is a block diagram of a typical internal combustion engine 300. The engine 300 includes a first cylinder 301 having a first spark plug 311, a second cylinder 302 having a second spark plug 312, a third cylinder 303 having a third spark plug 313, a fourth cylinder 304 having a fourth spark plug 314, a fifth cylinder 305 having a fifth spark plug 315, and a sixth cylinder 306 having a sixth spark plug 316. Of course, many varieties of engines exist. The most prominent forms are four, six, eight, and twelve cylinder engines.

The engine 300 also includes a distributor 320. A first link 321, or spark plug wire, links the distributor 320 to the first spark plug 311. A second link 322 links the distributor 320 to the second spark plug 312. A third link 323 links the distributor 320 to the third spark plug 313. A fourth link 324 links the distributor to the fourth spark plug 314. A fifth link 325 links the distributor to the fifth spark plug 315. A sixth link 326 links the distributor to the sixth spark plug 316.

During operation of the engine 300, the first cylinder 301 fills with air and fuel. The first spark plug 311 forces electricity to arc across an air gap in the first spark plug 311. This electricity, or spark, across the air gap ignites the fuel and air mixture, which forces a piston to move. In order for the electricity to travel across the air gap of the spark plug, the electricity must be at a very high voltage. Preferably, the voltage is between 10,000 and 100,000 volts. Typically, the voltage is not greater than 50,000 volts.

The distributor 320 is also linked to an ignition coil 330 via a coil wire 332. The coil wire 332 is an insulated, high-voltage wire. The ignition coil 330 is a device that generates the high voltages required to create the arcing of electricity across the air gap in the spark plug, for example the first spark plug 311. The ignition coil 330 is essentially a high-voltage transformer made up of a first coil of wire 334, typically called a primary coil, and a second coil of wire 336, typically called a secondary coil. The second coil 336 is wrapped around the first coil 334. The second coil 336 typically has hundreds of times more turns of wire than the first coil 334. The ignition coil 330 also includes a positive terminal 338 and a negative terminal 340.

The ignition coil 330 is linked to a battery 342 through a switch 349, i.e. an ignition switch. Typically, the battery 342 is a 12-volt battery having a positive terminal 346 and a negative terminal 348. Current flows from the battery 342 through the first coil 334 when the ignition switch 347 is in the “on”, or closed, position. The first coil 334 will have a magnetic field associated with it. When this circuit is suddenly broken, by breaker points (or by a solid-state device in an electronic ignition) the magnetic field of the first coil 334 collapses rapidly. The second coil 336 of the ignition coil 330 is engulfed by a powerful magnetic field. This field induces a current in the second coil 336 with a very high voltage of up to 50,000 volts because of the number of coils in the secondary winding of the second coil 336. The second coil 336 feeds this voltage to the distributor 320 via coil wire 332.

The distributor 320 distributes this high voltage to the spark plugs 311-316 of the cylinders 301-306, respectively, via links 321-326, respectively, in a firing order. The firing order is the order in which the cylinders 301-306 fire or ignite the fuel and air mixture within them. This firing order is specific to each type of engine. In the example embodiment illustrated and discussed herein, the cylinders 301-306 fire in order with the first cylinder 301 being first, then the second cylinder 302, and so on until the sixth cylinder 306 fires. During the operation of the engine 300, this firing sequence repeats itself numerous times.

The combustion process of an internal combustion engine is known to one skilled in the art. In general, the battery 342 provides power to the ignition coil 330 when the ignition switch 349 is thrown. The ignition coil 330 provides a very high, charged voltage to the distributor 320. The distributor 320 creates re-occurring ignition signals (one ignition signal for each spark plug 311-316 of the engine 300) and causes a cylinder 301-306 to fire by applying a high voltage to the spark plug 311-316 of that cylinder 301-306. The spark plug 311-316 supplies a spark that ignites the air and fuel mixture in the cylinder 301-306 so that combustion can occur, thus creating power, or work.

Unfortunately, it is not uncommon to have a cylinder 301-306 not fire correctly. This is commonly referred to as a misfire. If a cylinder 301-306 does not fire correctly, then the engine 300 loses power and will run roughly. Because each of the cylinders 301-306 contribute some power through combustion of the fuel and air in that cylinder 301-306 to the overall power of the engine, if a cylinder 301-306 misfires, there will be a drop in power in the engine 300. Cylinder 301-306 misfires can happen for a variety of reasons, for example, a bad spark plug, bad spark plug wire, a faulty distributor, including the rotor, cap, and primary circuits, a faulty coil, or the like. Diagnosing such misfires is an important diagnostic tool for mechanics or technicians of an internal combustion engine.

In today's cars, electronics control and monitor almost every function of the car. These electronics include an on-board information system 378 that includes Electronic Control Units (ECU) 380 and On-Board Diagnostics (OBD) ECU systems 382. Typically, the OBD's 382 are contained within an ECU 380, or in other words, the ECU 380 includes control software and diagnostic software. However, for this example, the ECU 380 and OBD 382 are shown separately.

Vehicles typically have ten or more ECUs 380. These ECUs 380 contain a large amount of software. The OBD system 382 also includes a large amount of software. Part of the OBD system 382 is required by government regulations to indirectly monitor the vehicle's emissions by monitoring the operation of the vehicle's emission control systems. Typically, there is more diagnostic software, for example in a vehicle's power train ECU, than there is control software.

The on-board information system 378 monitors many components of the vehicle and engine. For purposes of this disclosure, the main functions can be categorized as engine misfire, ignition coil failure, and fuel injector breakdown. When the on-board information system 378 encounters problems, defined by components not operating in a pre-described fashion, the on-board information system 378 stores information about the specific problem it has observed, and makes this information available to other devices. This information about the specific problem is commonly referred to as Freeze Frame data. This data can include, for example, the engine RPM, engine temperature, vacuum pressure, vehicle speed, and the like.

Often, when the on-board information system 378 detects a problem, especially if the problem is severe, the on-board information system 378 will prompt the operator of the vehicle with a message, for example, a “Check Engine” light or some other indicator, indicating a severe problem has been observed in the vehicle and service is required.

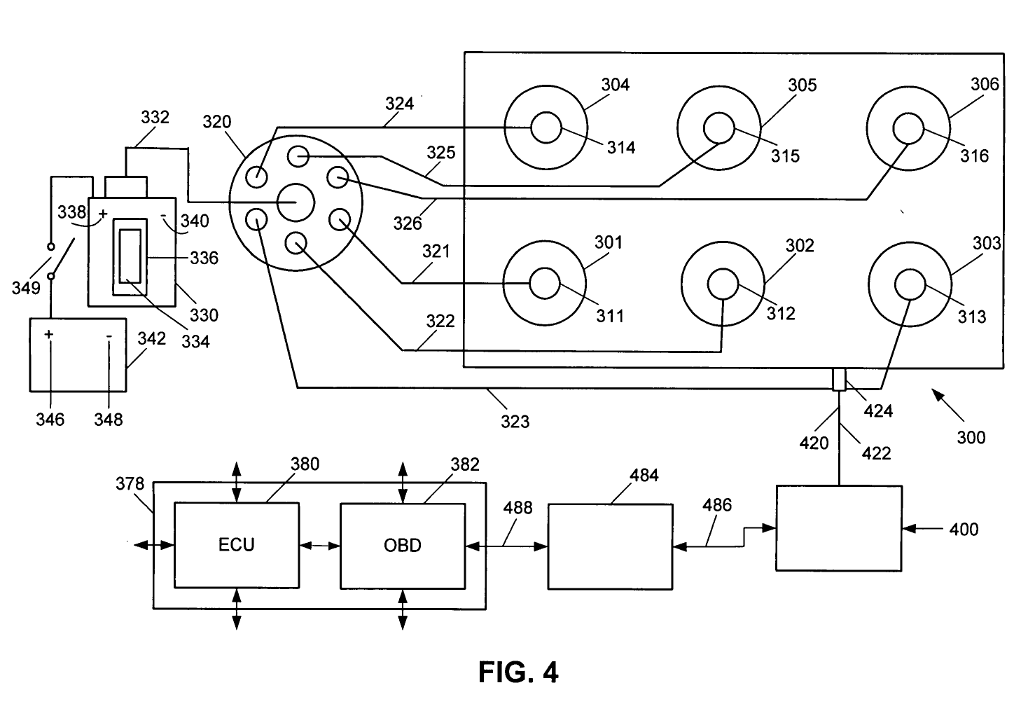

FIG. 4 is a block diagram of the internal combustion engine 300 of FIG. 3 with a diagnostic system 400 shown. The diagnostic system 400 is connected to a vehicle's data connector 484, or DLC, via a data link 486, or vehicle data link or vehicle network. Preferably, this data connector 484 is an SAE J1962/ISO 15031-3 data link connector, commonly found on vehicles and located under the dash inside of the vehicle. The data connector 484 is connected to a vehicle's on-board information system 378, including the ECUs 380 and the OBDs 382, via link 488. In this example embodiment, a single diagnostic system 400 is illustrated with a data link 486. The diagnostic system 400 communicates with the on-board information system 378 via the data connector 484 using standard communicating protocols. In alternative embodiments, there might be additional components. For example, the single diagnostic system 400 might require a data connection module (not shown) to connect to the data connector 484.

The diagnostic system 400 can also include a first device 420. The first device 420 can be a first probe 422, such as a vacuum probe commonly known. The first device 420 can be connected to a vacuum port 424 of the engine 300.

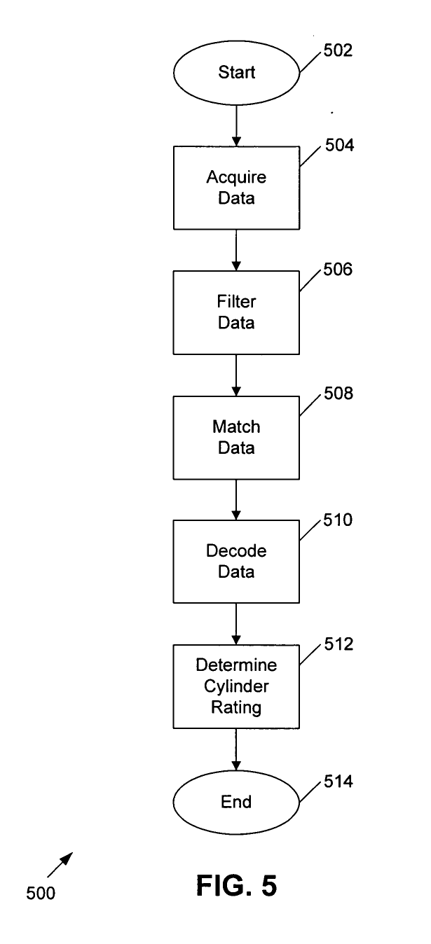

FIG. 5 illustrates an operational flow of a diagnostic system 500, according to an example embodiment of the present disclosure. In general the diagnostic system 500 describes a method for identifying single or multiple failed cylinders of an internal combustion or compression ignition engine. The vehicle OBD system is utilized to determine any or all in-operative cylinders.

Operational flow begins at a start point 502. An acquire operation 504 acquires data from the vehicle OBD system, such as the OBD 382 of FIG. 3. This data includes DTC, pending DTC and freeze frame data. Masking of the data is performed for DTC and pending DTC data that can be used to identify a possible misfire related problem. In this disclosure, the DTC and pending DTC data used to identify misfire related problems is referred to as target DTC data.

A filter operation 506 filters certain types of codes from the data that are irrelevant to an in-operative cylinder evaluation. Such codes can includes error codes dealing with other parts of the vehicle, and for example, can include standard vehicle codes such as “B”, “C”, “U”, and “P” codes.

A match operation 508 matches the remaining DTC data and pending DTC data to a lookup table. Preferably, the lookup table includes a listing of the relevant DTC and pending DTC data that are relevant to an in-operative cylinder evaluation. DTC data and pending DTC data that matched against the lookup table are used as target DTC data.

A decode operation 510 decodes the target DTC data. The decode operation 510 decodes the target DTC data by applying it against the lookup table. The lookup data can include, for example, DTC data and the corresponding meaning of the DTC data. Once decoded, each target DTC data produces data on the system group (for example, ignition system, fuel system, etc.), cylinder information (for example the cylinder number, coil pack number, fuel injector number, etc.), specific description (for example, misfire, circuit low, contribution/balance, etc.), a recommended action, and the cylinder ID or number.

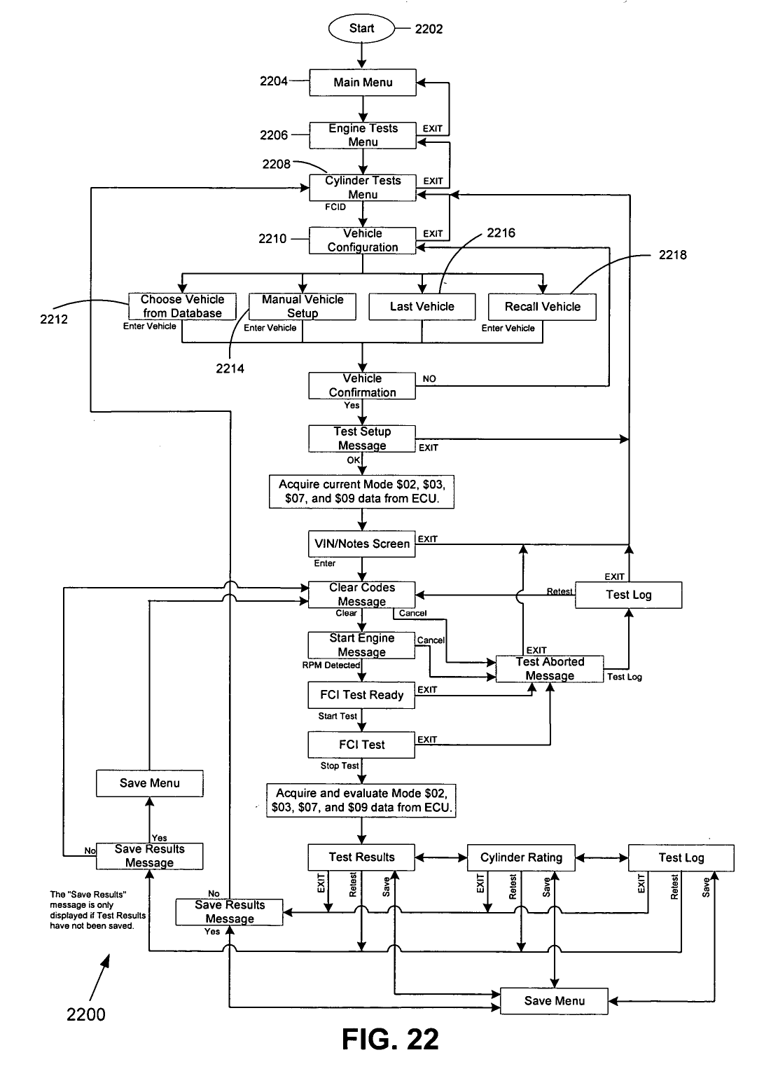

A determine cylinder rating operation 512 determines the rating of the cylinder. The rating operation 512 identifies the cylinder ID number and whether the cylinder is good (“OK”) or not good (“NG”). These results can be displayed to the user as described in connection with FIG. 22.

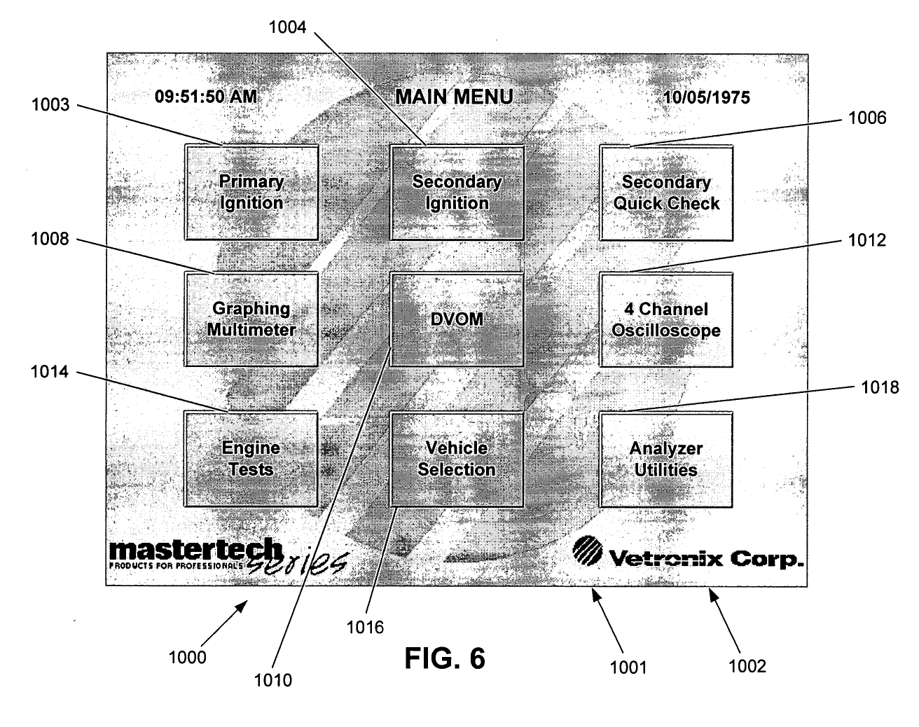

FIGS. 6-21 are illustrative screen-shots of a diagnostic system's 1000 user interface 1001, according to an example embodiment of the present disclosure. FIG. 6 illustrates a main menu 1002. A variety of possible functions are listed for the diagnostic system 1000. These functions include Primary Ignition 1003, Secondary Ignition 1004, Secondary Quick Check 1006, a Graphing Multimeter 1008, a DVOM 1010, a 4 Channel Oscilloscope 1012, Engine Tests 1014, Vehicle Selection 1016, and Analyzer Utilities 1018. Preferably, the user interface utilizes a touch-screen display, as is known in the art, so that the user can simply touch the key, or button, to which he wants to select. Of course, any suitable interface could be used. In this example, the user selects the Engine Tests key 1014 by touching the screen where it says “Engine Tests”.

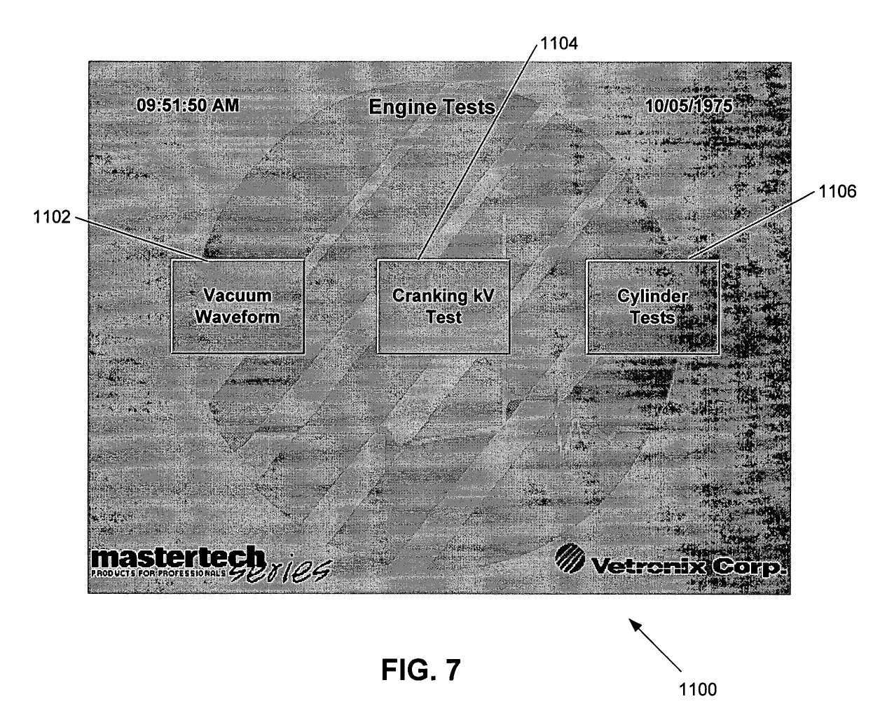

FIG. 7 illustrates the Engine Tests Screen 1100. Under the Engine Tests mode 1100 of the diagnostic system 1000, the user can select Vacuum Waveform 1102, Cranking kv Test 1104, or Cylinder Tests 1106. In this example, the user selects the Cylinder Test 1106 key.

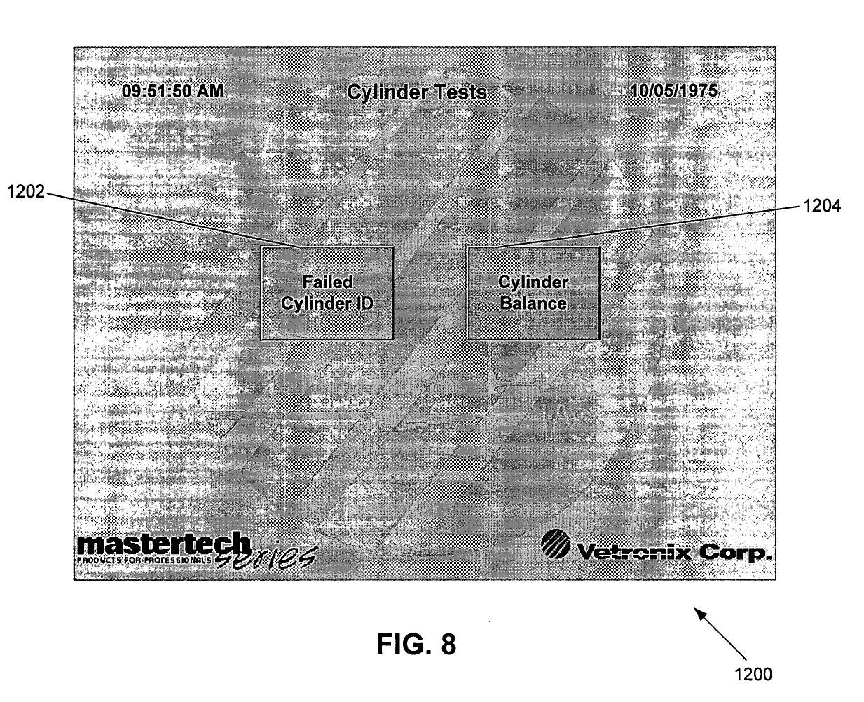

FIG. 8 illustrates the Cylinder Tests screen 1200. Under the Cylinder Tests mode 1200 of the diagnostic system 1000, the user can select Failed Cylinder ID 1202 or Cylinder Balance 1204. In this example, the user selects the Failed Cylinder ID key 1202.

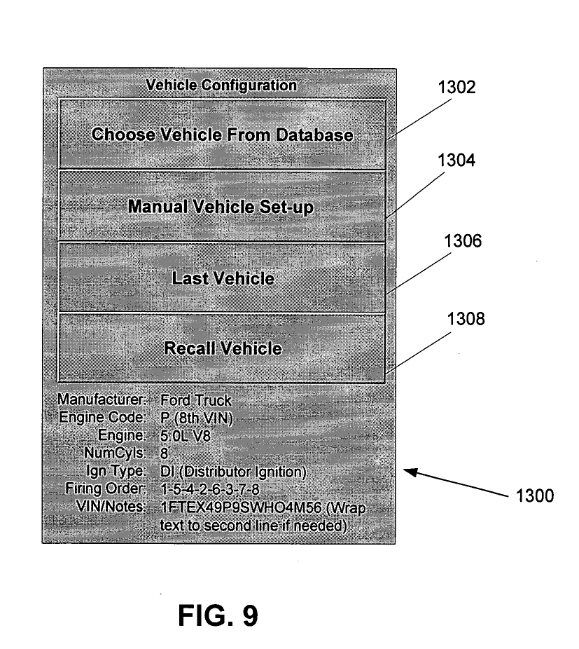

FIG. 9 illustrates a Vehicle Configuration Screen 1300. When the user selected the Failed Cylinder ID key 1202 on the Cylinder Tests screen 1200 of FIG. 8 the Vehicle Configuration Screen 1300 appears. The diagnostic system 1000 needs to know which vehicle is being diagnosed, or more particularly which engine is being diagnosed, because each engine has unique attributes, for example, the number of cylinders, the dwell period of the cylinder, and the firing order of the cylinders. Under the Vehicle Configuration screen 1300, the user has the option of selecting Choose Vehicle from Database 1302, Manual Vehicle Set-up 1304, Last Vehicle 1306, or Recall Vehicle 1308.

The diagnostic system 1000 includes numerous vehicles in its database. The user of the diagnostic system 1000 can select the Choose Vehicle from Database 1302 key to select a vehicle from the database. Alternatively, the user can select the Manual Vehicle Set-up key 1304 to manually enter information about the vehicle's engine. Such information might include the manufacturer, the engine code, the engine type, the number of cylinders, the ignition type, the firing order, and the Vehicle Identification Number (VIN). In addition, the user could select the Last Vehicle key 1306. Doing so would use the information on the last vehicle tested by the diagnostic system 1000 to perform the current diagnosis. Furthermore, the user could select the Recall Vehicle key 1308. The diagnostic system 1000 can store information related to numerous vehicles that have been previously tested. Thus, if a vehicle has been in for testing before, that vehicle would be in the recall vehicle database and can be selected.

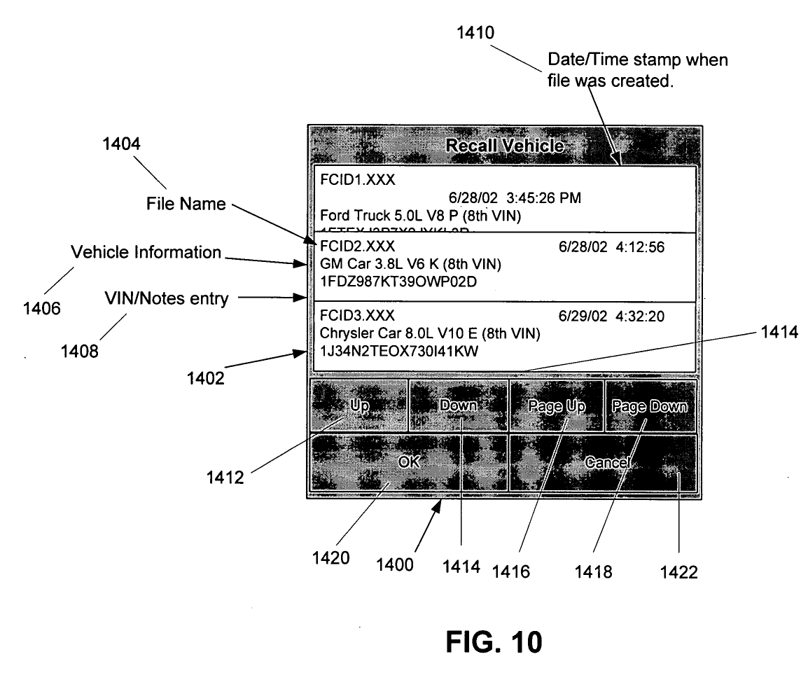

FIG. 10 illustrates the screen 1400 that would be displayed if the user selected the Recall Vehicle key 1308 of FIG. 9. The Recall Vehicle screen 1400 includes a scrollable list 1402 of previously stored vehicles. The list would include information such as the file name 1404, the vehicle information 1406, the VIN/notes entry 1408, and a date/time stamp 1410 of when the file was created. The user can scroll through the list 1402 by using the Up 1412 and Down 1414 keys illustrated. To scroll the list 1402 by page, the user can select the Page Up key 1416 or the Page Down key 1418. The user can select the vehicle by pressing on the vehicle in the list 1402 and then selecting the OK key 1420. The user can go back a screen by selecting the Cancel key 1422.

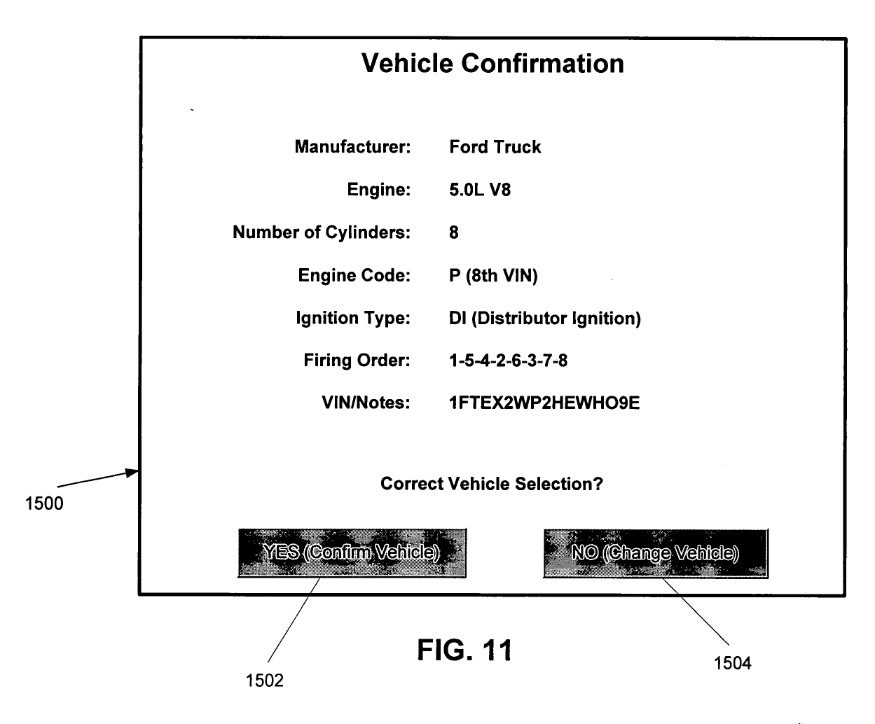

By selecting a vehicle and hitting the OK key 1420, a Vehicle Confirmation screen 1500 is displayed as illustrated in FIG. 11. Of course, entering a vehicle by one of the other methods illustrated in connection with FIG. 9 would also result in the display of the Vehicle Confirmation screen 1500. The user simply confirms that the vehicle displayed in the screen 1500 is the correct vehicle by hitting the YES key 1502. If the Vehicle is incorrect, the user can select the NO key 1504 and return to the Vehicle Configuration screen of FIG. 9.

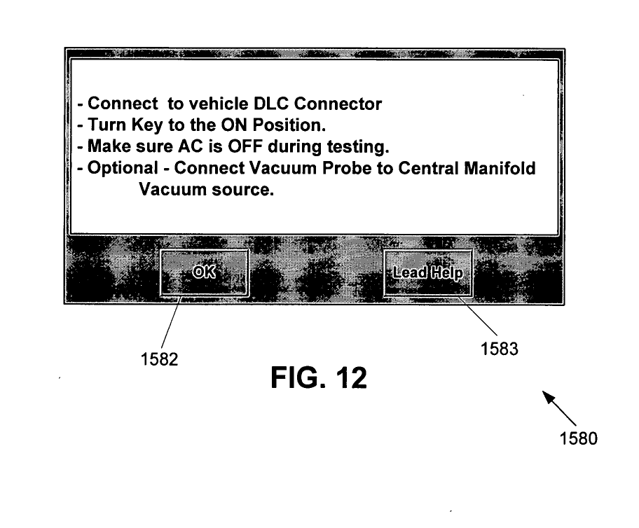

FIG. 12 illustrates instructions 1580 provided to the user of the diagnostic system 1000. These instructions 1580 can include, for example, Connect to Vehicle DLC Connector, for example, data connector 484 of FIG. 4, Turn Key to the On Position, Make Sure AC is OFF during testing, and connect the optional Vacuum Probe, for example the first device 420 of FIG. 4, to Central Manifold Vacuum source. The user can select the Continue key 1582 to proceed. The user could also select a lead help key 1583 for information on how to connect the diagnostic system 1000.

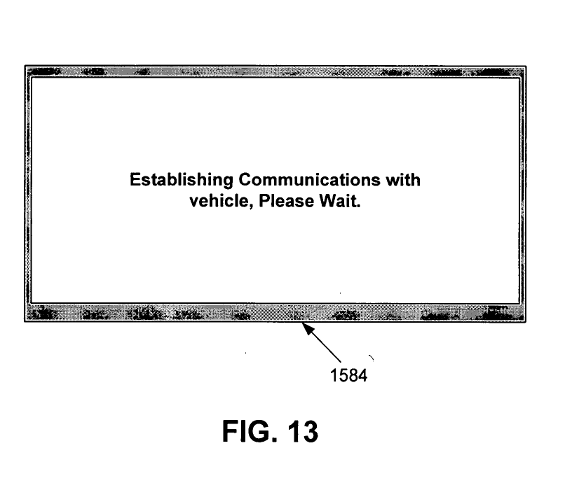

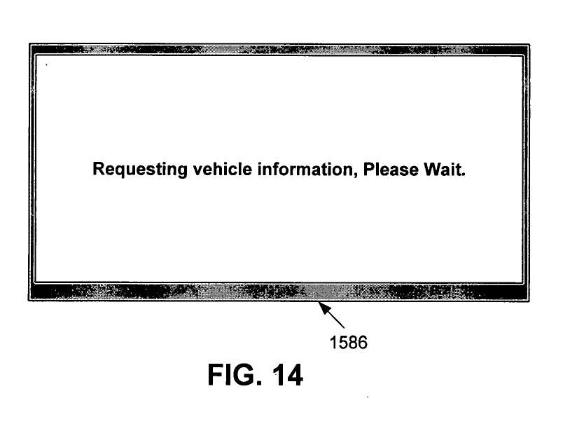

After the user selects the Continue key 1582 in FIG. 12, the diagnostic system 1000 begins to access the information system of the vehicle, such as 378 of FIG. 3, to retrieve data. FIG. 13 includes further communications 1584 to the user, for example, “Establishing Communications with Vehicle, Please Wait.” FIG. 14 includes further communications 1586 to the user as well, for example, “Requesting Vehicle Information, Please Wait.” The information request might include the engine coolant temperature, the engine RPM, the vehicle speed, the throttle position, and the calculated load at the time the error occurred.

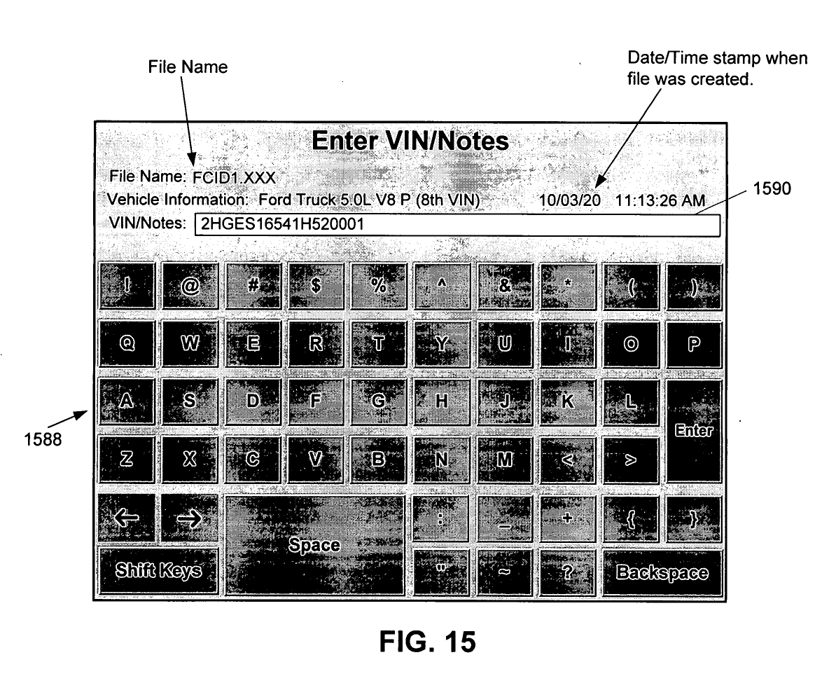

After the diagnostic system 1000 has accessed the data from the information system, the diagnostic system 1000 presents a VIN/Notes screen 1588 to the user as illustrated in FIG. 15. If a valid VIN number has been received from the vehicle, the VIN number shall be displayed in field 1590. If a valid VIN number has not been received from the vehicle, field 1590 shall be blank so the user can enter one. Most modern vehicles include the VIN number in the information contained in the on-board information system. It is noted that in previously entering the Vehicle Configuration screen 1300 of FIG. 9, the VIN number may already exist.

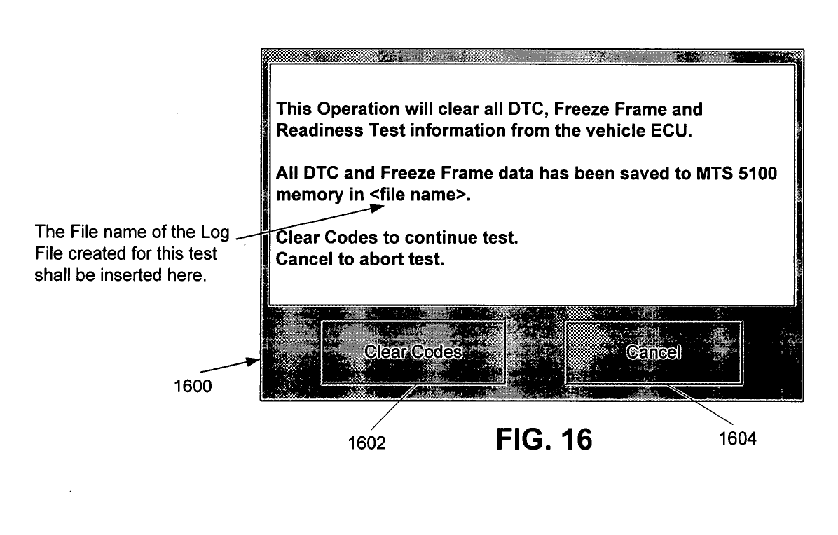

The diagnostic system 1000 advances to FIG. 16. FIG. 16 displays a message 1600 to the user, for example, “This Operation will clear all DTC, Freeze Frame and Readiness Test information from the vehicle ECU. All DTC and Freeze Frame data has been saved to MTS memory in <file name>. Clear Codes to continue test. Cancel to abort test.” Of course, the <file name> referred to would display an actual file name associated with this vehicle, test, and data received.

The user can either select a Clear Codes key 1602 or a Cancel key 1604. The Clear Codes key 1602 will clear any error data in the on-board information system, since the data has been downloaded already to the diagnostic system 1000. If the user does not wish to clear this data, the user can select the Cancel key 1604 and the test will be aborted.

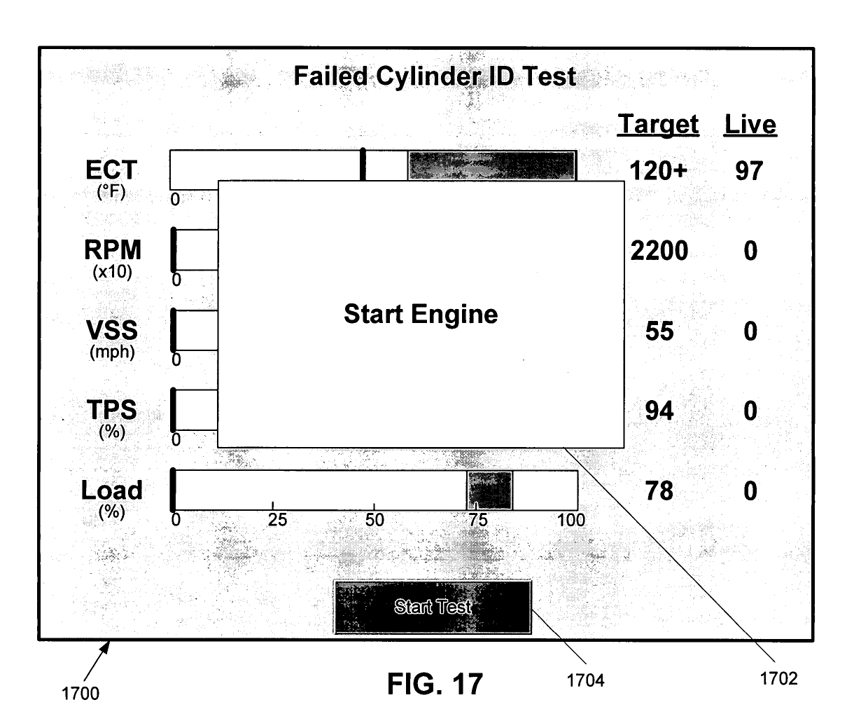

If the user selects the Clear Codes key 1602, the diagnostic system 1000 advances to the Failed Cylinder ID Test screen 1700 of FIG. 17. An overlying message 1702 is displayed to the user providing additional instructions, such as “Start Engine”. In this example, the “Start Engine” message shall be displayed until an engine running condition is detected. It is noted that during testing, the diagnostic system 1000 remains connected to the vehicle's on-board information system, such as on-board information system 378 of FIG. 3, through a data connector, such as the data connector 484 of FIG. 4.

After an engine running condition is detected, another message (not shown) shall be displayed to the user, such as “FCID Test Ready”. The user can then use the Start Test Key 1704 to begin the test. The diagnostic system 1000 tests the vehicle to determine the condition of each cylinder.

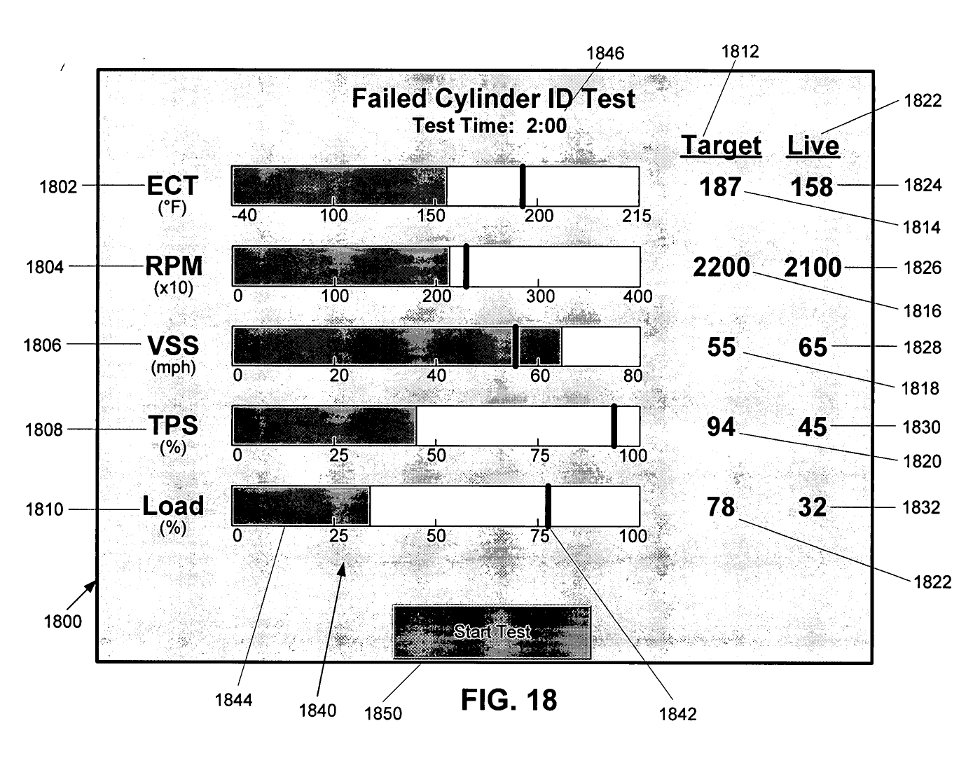

FIG. 18 illustrates a Failed Cylinder ID Test screen 1800 during testing of the vehicle. On this screen 1800 data, such as engine coolant temperature (ECT) 1802, RPM 1804, vehicle speed sensor (VSS) 1806, throttle position sensor (TPS) 1808, and calculated load 1810, are displayed. A target column 1812 displays target data, such as the ECT 1814, RPM 1816, VSS 1818, TPS 1820, and Load 1820. The target column 1812 represents data, or Freeze Frame data, from the on-board information system reflecting the actual conditions during the observed error. A live column 1822 displays instantaneous data, such as ECT 1824, RPM 1826, VSS 1828, TPS 1830, and Load 1832. The live, or instantaneous, column 1822 represents current data during testing.

It is desirable for the diagnostic system 1000 to run the failed cylinder test in conditions that approximate the actual conditions where the error occurred. In other words, it is desirable for the live data to approximate the target data during testing.

A graphical representation 1840 of the target and live data is also displayed in a bar graph. A solid line 1842 indicates the target data 1812 while the grayed or highlighted area 1844 represents the live data. A Test Timer field 1846 indicates the length of time of the test.

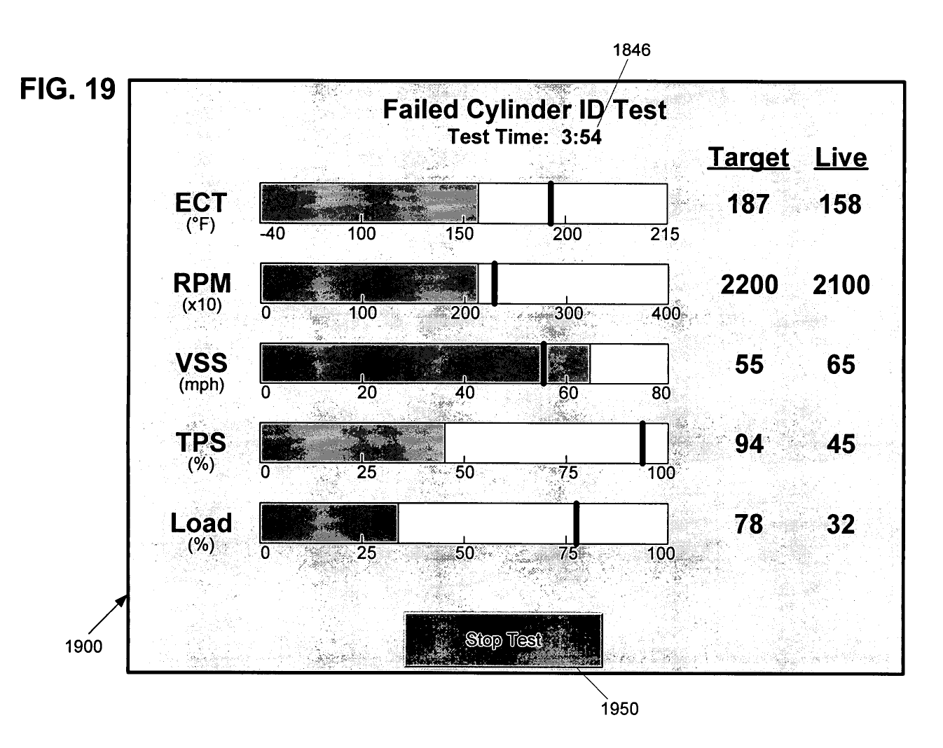

The user presses a Start Test key 1850 to begin the test. FIG. 19 illustrates a failed cylinder ID test screen 1900 during testing. It is noted that the Start Test key 1850 from FIG. 18 now displays as a Stop Test key 1950. The testing continues until the test timer 1846 reaches zero, or the user presses the Stop Test key 1950.

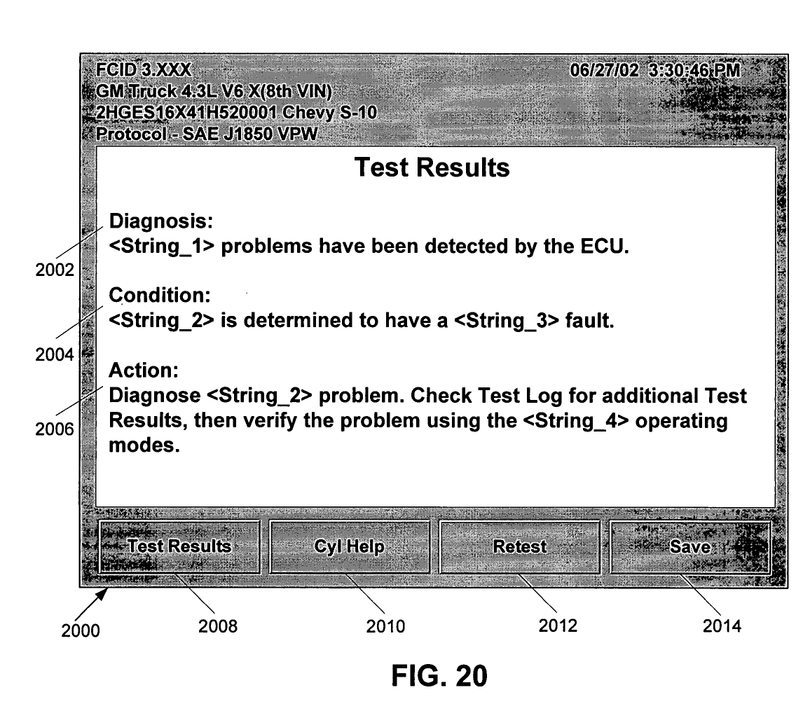

Upon completion of the test by the diagnostic system 1000, a Test Results message 2000 is displayed as illustrated in FIG. 20. The Test Results message 2000 displays a Diagnosis 2002, Condition 2004, and Action 2006. The <string> conditions are completed with the data reported from the vehicle on-board information system, such as on-board information system 378 of FIG. 3.

The Test Results message screen 2000 includes a Test Results key 2008, a Cyl Help key 2010, a Retest key 2012, and a Save key 2014. The Test Results key 2008 can be pressed to display the actual test results. The Cyl Help key 2010 can be pressed to display an applicable Cylinder Help bitmap. The Retest key 2012 can be pressed to return to the message screen 1600 of FIG. 16. The Save key 2014 can be pressed to save the test results for later recall.

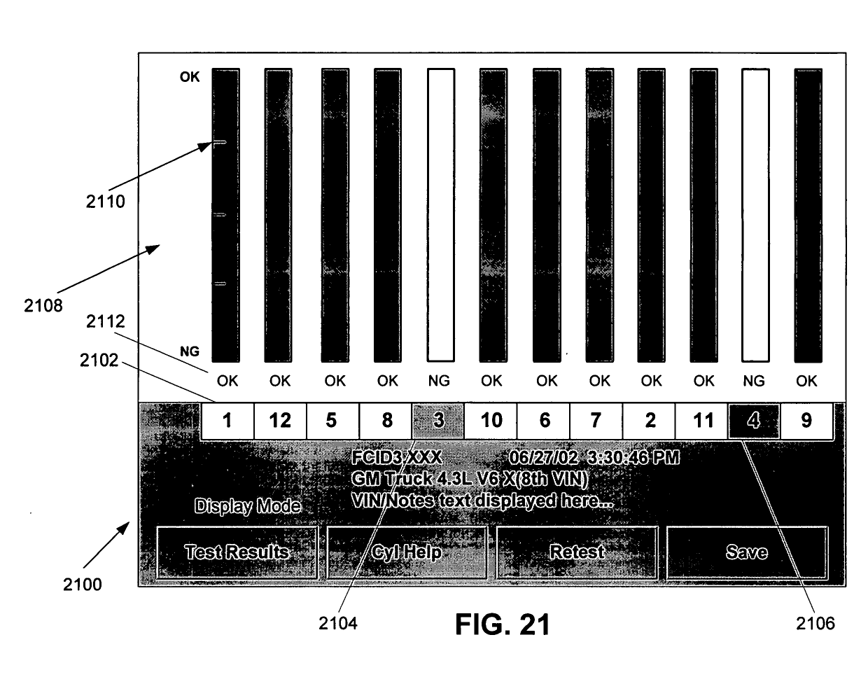

If the Test Results key 2008 is pressed, a Test Results screen 2100 is displayed as illustrated in FIG. 21. The cylinders are displayed in cylinder fields 2102. It is noted that a 12 cylinder engine was used in this example embodiment. Cylinders that have been determined to have failed are shaded as illustrated in the third 2104 and fourth cylinders 2106. A graphical representation 2108 of a cylinder's performance is illustrated as bars 2110. The shaded area of the bars 2110 illustrates the rating of each cylinder. Below each bar, a textual representation 2112 of the cylinder either passing or failing as indicated performance is indicated. In FIG. 21, results are illustrated where the results were derived from one or more cylinder specific misfire related codes only. In this example, “OK” means the cylinder is ok, or passed, and “NG” means the cylinder is not good, or failed.

Although not shown, the diagnostic system 1000 contains additional functionality. Some example of such functionality include displaying the actual data collected in its raw form; providing a display mode that allows a user to see the test log, cylinder rating, or test results; and if the diagnostic system 1000 cannot communicate with the vehicle a message indicating such with additional instructions can be displayed. The results of the any of the tests can be saved for later recall or printed. The user can also configure the diagnostic system 1000, for example, by changing the units of measure.

FIG. 22 illustrates an operational flow 2200 of the diagnostic system 1000, described herein in connection with FIGS. 6-21, according to an example embodiment. Operational flow begins at a start point 2202. The operational flow 2200 illustrated describes the functions and displays described herein and also illustrates some additional functionality of the diagnostic system 1000.

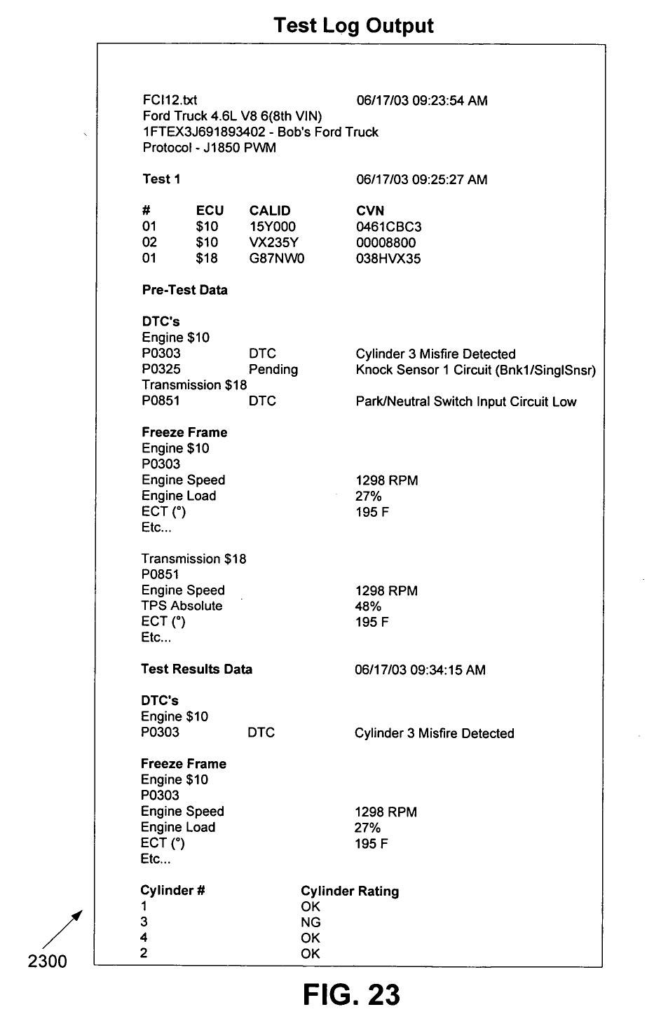

FIG. 23 illustrates an example test log output, according to an example embodiment.

The above discussion can best be understood in terms of application examples. In a first application example, referring to FIGS. 3 and 4, an automobile owner brings their automobile to a technician complaining of loss of power and a rough running engine 300. The technician connects the diagnostic system 400 to the vehicle as described in connection with FIG. 4.

Referring to FIGS. 6-21, the technician pushes the Engine Tests key 1014, the Cylinder Tests key 1106, the Cylinder Balance key 1204, and the Recall Vehicle key 1308. This owner has been in for similar problems in the past, so the vehicle information has been previously stored in the diagnostic system 400. If this had been a new owner, the technician could have pushed the Choose Vehicle from Database key 1302 or the Manual Vehicle Set-up key 1304. The technician selects the vehicle from the stored list 1402, pushes the OK key 1420, and confirms the vehicle with the YES key 1502. Because the technician already connected the diagnostic system 400 in accordance with FIG. 4 and has already complied with the remaining instructions, the technician pushes the OK key 1582.

A message 1584 is displayed to the user while the diagnostic system 400 establishes communications with the vehicle. Another message 1586 is displayed to the user while the diagnostic system 400 requests vehicle information. Referring to FIG. 17, a “Start Engine” message 1702 is displayed to tell the technician to start the vehicle engine. In FIGS. 18 and 19, the actual testing process is displayed to the technician. The test results 2000 are displayed in FIG. 20. In FIG. 21 the cylinder rating results are displayed.

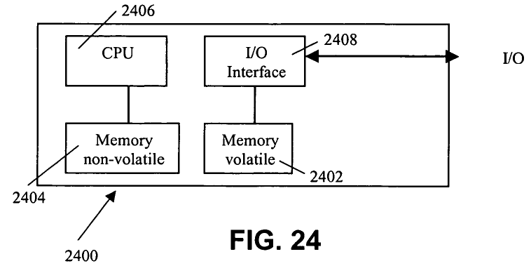

A hardware model could be used to implement a diagnostic system based on the methodology described above. FIG. 24 illustrates the minimum hardware that is required to implement a diagnostic system 2400. The diagnostic system typically includes a volatile memory 2402, such as a RAM, a non-volatile memory 2404, such as an EPROM, FLASH, or a hard drive, a CPU 2406, and an Input/Output (I/O) Interface 2408. The non-volatile memory 2404 could be any type and is used to store the control program and data associated with user controls and test data described above. The volatile memory 2402 could be any type and is used to store user variables, calculations, and storing an image of the I/O data. The I/O Interface 2408 converts data from a system bus to an I/O bus, which could be serial or parallel and could use any type of encoding scheme, or none at all.

One skilled in the art would recognize that the system described herein can be implemented using any number of configurations.

The logical operations of the various embodiments illustrated herein can be implemented (1) as a sequence of computer implemented steps or program modules running on a computing system and/or (2) as interconnected logic circuits or circuit modules within the computing system. The implementation is a matter of choice dependent on the performance requirements of the computing system implementing the invention. Accordingly, the logical operations making up the embodiments of the present invention described herein are referred to variously as operations, steps, engines, or modules.

The various embodiments described above are provided by way of illustration only and should not be construed to limit the invention. Those skilled in the art will readily recognize various modifications and changes that may be made to the present invention without following the example embodiments and applications illustrated and described herein, and without departing from the true spirit and scope of the present invention, which is set forth in the following claims.

1. A method of determining a cylinder that has a failure in an engine, the method comprising:
accessing an on-board information system associated with the engine;
retrieving data from the on-board information system;
filtering the data to derive at target data; and
decoding the target data to determine a number of a failed cylinder and the cylinder's corresponding cylinder rating.

2. A method according to claim 1 wherein:
accessing an on-board information system includes accessing an on-board diagnostic device associated with the engine.

3. A method according to claim 1 wherein:
retrieving data from the on-board information system includes retrieving fault data from the on-board information system.

4. A method according to claim 1 wherein:
accessing an on-board information system includes connecting a diagnostic system to a data connector associated with the on-board information system.

5. A method according to claim 1 further comprising:
connecting a first probe to the engine.

6. A method according to claim 5 wherein:
connecting a first probe includes connecting a vacuum probe to a vacuum port of the engine.

7. A method according to claim 1 wherein:
filtering the data includes matching the data to a lookup table to derive target data.

8. A system for determining a cylinder that has a failure in an engine, the system comprising:
a access module that accesses an on-board information system associated with the engine;
a retrieve module that retrieves data from the on-board information system;
a filter module that filters the data to derive at target data; and
a decode module that decodes the target data to determine a number of a failed cylinder and the cylinder's corresponding cylinder rating.

9. A system according to claim 8 wherein:
the access module accesses an on-board diagnostic device associated with the engine.

10. A system according to claim 8 wherein:
the retrieve module retrieves fault data from the on-board information system.

11. A system according to claim 8 wherein:
the access module connects to a data connector associated with the on-board information system.

12. A system according to claim 8 further comprising:
a connect module that connects a first probe to the engine.

13. A system according to claim 12 wherein:
the connect module connects a vacuum probe to a vacuum port of the engine.

14. A system according to claim 8 wherein:
the filter module matches the data to a lookup table to derive target data.

15. A computer program product readable by a computing system and encoding instructions for determining a cylinder that has a failure in an engine, the computer process comprising:
accessing an on-board information system associated with the engine;
retrieving data from the on-board information system;
filtering the data to derive at target data; and
decoding the target data to determine a number of a failed cylinder and the cylinder's corresponding cylinder rating.

16. A computer program product according to claim 15 wherein:
accessing an on-board information system includes accessing an on-board diagnostic device associated with the engine.

17. A computer program product according to claim 15 wherein:
retrieving data from the on-board information system includes retrieving fault data from the on-board information system.

18. A computer program product according to claim 15 wherein:
accessing an on-board information system includes connecting a diagnostic system to a data connector associated with the on-board information system.

19. A computer program product according to claim 15 further comprising:
connecting a first probe to the engine.

20. A computer program product according to claim 19 wherein:
connecting a first probe includes connecting a vacuum probe to a vacuum port of the engine.

21. A computer program product according to claim 15 wherein:
filtering the data includes matching the data to a lookup table to derive target data.

22. A system for diagnosing an internal combustion engine, the system comprising:
a computing system that executes an algorithm that evaluates a contribution of a cylinder in the internal combustion engine;
a connection device that connects the computing system to an on-board information system associated with the internal combustion engine; and
a first device that connects the computer system to a vacuum port of the internal combustion engine.

23. A graphical user interface used in conjunction with a diagnostic system for diagnosing an internal combustion engine having a plurality of cylinders, the graphical user interface comprising:
a first field that displays target information regarding the internal combustion engine;
a second field that displays instantaneous information regarding the internal combustion engine; and
a graphical representation of the first field and the second field.
